(19) United States
(12) Patent Application Publication
(10) Pub. No.: US 2020/0307110 A1
(43) Pub. Date: Oct. 1, 2020

(54) NOISE REDUCTION VIBRATION WELDING MACHINE USING FREQUENCY CANCELLATION

(71) Applicant: Young In BAEK, Yangju-si (KR)

(72) Inventor: Young In BAEK, Yangju-si (KR)

(21) Appl. No.: 16/699,437

(22) Filed: Nov. 29, 2019

(30) Foreign Application Priority Data
Mar. 26, 2019 (KR) 10-2019-0034010

(51) Int. Cl. B29C 65/02; B29C 65/00

(52) U.S. Cl. CPC B29C 65/022; B29C 66/9121; B29C 66/951

(57) ABSTRACT

The present disclosure relates to a noise reduction vibration welding machine using frequency cancellation in which two synthetic resin products are fixed to an upper end jig and a lower end jig of the vibration welding machine and the target objects are welded by being melted and diffused while being subjected to the friction of lateral vibrations and pressed by the upper end jig according to a determined frequency and a determined amplitude, and which is capable of reducing noise generated during the work process, and more specifically, a frequency of noise generated due to vibrations during a work process is checked, and a noise analyzer, which generates a frequency with a reverse phase, outputs a cancellation sound through inner and outer speakers to cancel the corresponding frequency.

### CROSS-REFERENCE TO RELATED APPLICATION

This application claims priority to and the benefit of Korean Patent Application No. 10-2019-0034010, filed on Mar. 26, 2019, the disclosure of which is incorporated herein by reference in its entirety.

### BACKGROUND

### 1. Field of the Invention

The present invention relates to a noise reduction vibration welding machine using frequency cancellation, and more specifically, to a noise reduction vibration welding machine using frequency cancellation in which two synthetic resin products are fixed to an upper end jig and a lower end jig of the vibration welding machine and the target objects are welded by being melted and diffused while being subjected to the friction of lateral vibrations and pressed by the upper end jig according to a predetermined frequency and a predetermined amplitude, and which is capable of reducing the noise generated in such a work process.

### 2. Discussion of Related Art

In general, a vibration welding machine is a machine which is used when injection-molded objects formed of a synthetic resin are welded and in which two synthetic resin products to be welded are vibrated and rubbed against each other in a state in which pressure is applied to the two synthetic resin products, a melting process is performed at contact surfaces of the two synthetic resin products using instantaneous frictional heat, and thus a product having a firm bonding force is manufactured.

To this end, in Korean Patent Publication No. 10-1488738, a method of preventing the generation of a tip in vibration welding of a vibration welder and a device therefor are disclosed, the device including upper and lower work tables which are disposed in a lower end portion of a middle of inside of a main body, in which a jig including a heater installed in an upper portion to fix a lower product is installed and a servomotor is installed on a lower surface such that the upper and lower work tables vertically operate, and a vibration table which is installed above the upper and lower work tables, in which an upper product fixing jig is installed on a lower surface and a vibrational head is installed in an upper end portion.

However, in the related art, since noise generated during a work process of a vibration welding machine is not reduced or removed in the machine to a level which does not burden an operator, a method is used in which a separate soundproof door is installed to block the noise from an interior by opening or closing the door during the work process. This requires a structural design and manufacturing which consider the space where the soundproof door is installed and a soundproofing material capable of surrounding an entire surface of the machine, and due to a design limit in which the soundproofing material cannot be thick, noise, which is generated in the machine and can burden the operator or can cause temporary pain to the operator, can be transmitted to the outside.

### RELATED ART DOCUMENT

### Patent Document

Korean Patent Publication No. 10-1488738 (Jan. 27, 2015)

### SUMMARY OF THE INVENTION

The present invention is directed to providing a noise reduction vibration welding machine using frequency cancellation capable of reducing or removing corresponding noise by outputting a cancellation sound through inner and outer speaker to cancel a frequency, which generates noise, using an analyzer which generates a frequency with a reverse phase of a specific frequency of the noise generated due to vibration during a work process in which two synthetic resin products to be coupled are fixed to an upper end jig and a lower end jig and welded by being melted and diffused while being laterally vibrated and rubbed by the upper end jig according to a predetermined frequency and a predetermined amplitude.

According to an aspect of the present invention, there is provided a noise reduction vibration welding machine using frequency cancellation including a head frame in which a vibration spring is provided in a central portion and electromagnetic coils are provided at both side end portions of the vibration spring and which includes an upper end jig at an lower end portion and an upper end fixture under the upper end jig, a lower frame which supports both side surfaces of the head frame, includes a guide shaft coupling part inside an upper portion thereof, and is coupled to guide shafts, a pressing unit including a work table in which the guide shafts pass through both side end portions of the work table, a hydraulic cylinder under the work table, a lower end jig on the work table, and a lower fixture on the lower end jig, a soundproof case in which the head frame, the lower frame, and the pressing unit are installed, and a noise controller including a noise analyzer on one side surface inside the soundproof case, at least one or more speakers facing a noise source at each inner corner, an internal microphone in a central portion of the head frame, and a machine acceleration sensor on the electromagnetic coil, wherein outward speakers are provided in the soundproof case to face the outside where an operator is positioned.

More specifically, the noise analyzer may receive values of a frequency, an amplitude, and noise through components of the noise controller and output a cancellation sound having a phase signal with the same frequency and amplitude and a phase shifted by 180° through the speaker.

As another feature of the present invention, a temperature-measuring device may be provided in a central upper portion in the soundproof case, and an external microphone may be provided outside the soundproof case, wherein a frequency of generated noise may be transmitted as an input value of the noise analyzer.

As still another feature of the present invention, an acceleration sensor may be provided in the head frame in which the vibration spring is positioned, and acceleration sensors may be additionally provided on outer side surfaces of the upper end fixture and the lower fixture.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a front view illustrating a conventional vibration welding machine;

FIG. 2 is a front view illustrating a noise reduction vibration welding machine using frequency cancellation according to the present invention;

FIG. 3 is a plan view illustrating the noise reduction vibration welding machine using frequency cancellation according to the present invention; and

FIG. 4 is a side view illustrating the noise reduction vibration welding machine using frequency cancellation according to the present invention.

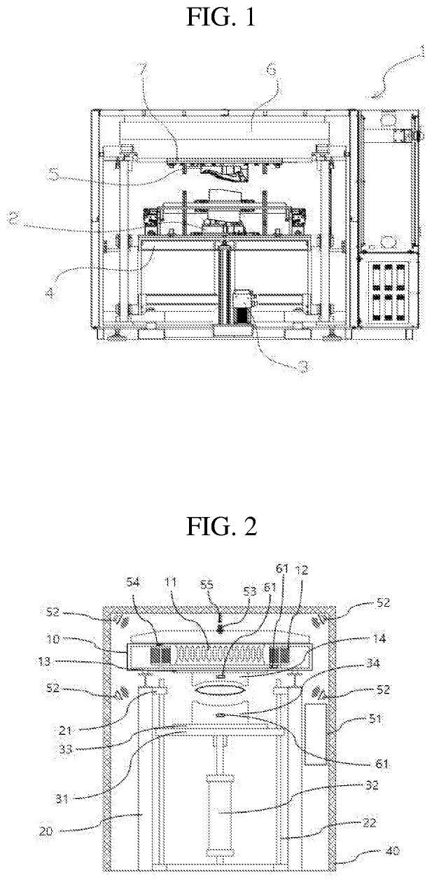

### DETAILED DESCRIPTION OF EXEMPLARY EMBODIMENTS

FIGS. 2 to 4 are front, plan, and side views illustrating a noise reduction vibration welding machine using frequency cancellation according to the present invention, and a detailed configuration of the present invention will be described below with reference to the accompanying drawings.

The noise reduction vibration welding machine using frequency cancellation includes a head frame 10 in which a vibration spring 11 is provided in a central portion and electromagnetic coils 12 are provided at both side end portions of the vibration spring 11 and which includes an upper end jig 13 at an lower end portion and an upper end fixture 14 under the upper end jig 13, a lower frame 20 which supports both side surfaces of the head frame 10, includes a guide shaft coupling part 21 inside an upper portion thereof, and is coupled to guide shafts 22, a pressing unit 30 including a work table 31 in which the guide shafts 22 pass through both side end portions, a hydraulic cylinder 32 under the work table 31, a lower end jig 33 on the work table 31, and a lower fixture 34 on the lower end jig 33, a soundproof case 40 in which the head frame 10, the lower frame 20, and the pressing unit 30 are installed, and a noise controller 50 including a noise analyzer 51 on one side surface inside the soundproof case 40, at least one or more speakers 52 facing a noise source at each inner corner, an internal microphone 53 in a central portion of the head frame 10, and a machine acceleration sensor 54 on the electromagnetic coil 12.

In addition, a temperature-measuring device 55 is provided in a central upper portion in the soundproof case 40, and external microphones 56 are provided outside of the soundproof case 40, and a frequency of noise checked at the outside by the external microphones 56 is transmitted as an input value of the noise analyzer 51.

Accordingly, in a state in which two synthetic resin products, which are injection-molded objects formed of a synthetic resin, are pressed, the two synthetic resin products are vibrated and rubbed against each other, a melting process is performed on the products using instantaneous frictional heat generated at contact surfaces thereof, and thus a product having a firm bonding force is manufactured. However, during such a work process, an amplifier receives a generated signal from the noise analyzer 51, which generates a frequency of which a phase is a reverse form of a phase of a specific frequency of noise generated due to vibrations, expands or amplifies the signal by a predetermined ratio to a level at which a speaker can operate, and outputs a cancellation sound wave through the speaker 52 installed in the machine to cancel the frequency causing the noise.

A noise level of a daily conversation is 65 dB, and a noise level of a street with heavy traffic, especially when a large truck passes by, ranges from about 80 to 90 dB. Exposure to noise in a workplace may cause gradual hearing loss, when the hearing loss continues for several years to several decades, a hearing impairment which interferes with communication in daily life may appear, and on average, when continuously exposed for about eight hours a day to 80 dB or more or for about 24 hours to 70 dB or more, a hearing impairment effect may be imparted. Since a level of noise generated in the vibration welding machine may be 75 dB or more and there is a risk of hearing loss in an operator due to a situation in which continuously exposure occurs in the workplace, associated risks may be reduced and the effect thereof may be minimized using the noise reduction vibration welding machine using frequency cancellation of the present invention.

The noise analyzer 51 receives values of a frequency, an amplitude, and noise through the components of the noise controller 50 and outputs a cancellation sound having a phase signal with the same frequency and amplitude and a phase shifted by 180° through the speaker 52, and thus noise can be reduced or removed. More specifically, noise generated in the machine is input through the internal microphone 53, data thereof is transmitted to the noise analyzer 51, and the machine acceleration sensor 54 obtains information about a frequency and an amplitude and transmits the information to the noise analyzer 51. In addition, the temperature-measuring device 55 measures a temperature value in the machine and transmits the corresponding information to the noise analyzer 51. The speed of sound, which is a speed at which a sound wave can propagate through air for a second, may be changed according to a temperature, and a value of the speed of sound may be calculated using v=(331.5+0.61T), wherein v is the speed of sound, and T is a temperature. Since a frequency has a value which is proportional to the speed of sound and inversely proportional to a wavelength, the speed of sound becomes faster when a temperature is higher, and conversely, slows when a temperature is lower. Based on such information about the noise, the frequency, the amplitude, and a temperature in the machine, the noise analyzer 51 generates a signal, in which the corresponding frequency and amplitude are maintained and which has a reverse phase, and outputs a cancellation sound wave through the speaker 52 included in the noise controller 50 so that the noise in the machine can be reduced or removed.

An acceleration sensor may measure system displacement using a spring and a mass and in a case in which an angular frequency to be measured is lower than a natural angular frequency of a mass portion, the displacement of the mass portion may correspond to acceleration. Acceleration sensors are classified into movable coil type, piezoelectric type, capacitive type, strain gauge type, servo type, and differential transformer type acceleration sensors. Among them, the movable coil type acceleration sensor measures an electromotive force generated when relative positions of a magnet mounted on a weight and a coil are changed, and the piezoelectric type, capacitive type, strain gauge type, and differential transformer type acceleration sensors detect the displacement of a mass portion using a piezoelectric element, a capacitor, a strain gauge, and a differential transformer. In addition, the servo type acceleration sensor measures acceleration through a current flowing through an operating coil when the displacement of a mass portion is set as zero using a servomechanism. The servo type sensor has superior linearity, and high degrees of precision and reliability.

In addition, the speakers 52 are provided at corners of upper end portions inside the soundproof case 40, two speakers 52 may be positioned at two lateral end portions of the corners facing the upper and lower end jigs which are noise sources, and the other speakers 52 may be positioned at two end portions of the other corners opposite to the two lateral end portions to face a direction, which is the same as a direction in which the two speakers 52 face, so that the other speakers 52 face the external microphone 56. In addition, an acceleration sensor 61 is provided in the head frame 10 in which the vibration spring 11 is positioned and acceleration sensors 61 are provided on outer side surfaces of the upper end fixture 14 and the lower fixture 34 to measure noise so that a cancellation sound wave with a phase opposite to that of the noise can be output in real time.

The external microphone 56 is positioned on an outer side surface of the soundproof case 40 at a height ranging from 1.6 m to 2 m from the ground surface, and the other external microphone 56 is additionally provided to be spaced 1 m to 2 m from the external microphone 56 and is provided at the same height as the external microphone 56, and thus a level of noise which can be actually heard by the operator may be optimized and collected.

Outward speakers 62 are provided to be positioned at a height ranging from 1.5 m to 2 m from the ground surface, and other outward speakers 62 are additionally provided on an outer side surface of the soundproof case 40 and are provided at the same height as the outward speakers 62 to face the operator. More specifically, the outward speakers 62 may be disposed at both end portions of the soundproof case 40, and the additional outward speakers 62 may be provided to be spaced 1 m to 2 m from the outward speakers 62 in a linear direction toward the outside from a vertical surface of the soundproof case 40, and the four outward speakers 62 may be provided facing a front surface or the operator.

The acceleration sensor 61 is a component capable of measuring vibrations heard as noise or felt as oscillations, may precisely measure an amplitude and a frequency in real time, and may transmit the amplitude and the frequency to the noise analyzer 51, and a noise cancellation sound may be generated by comprehensively analyzing information and may be output through the speakers 52 and the outward speakers 62.

Accordingly, since the components capable of cancelling noise in the vibration welding machine and noise heard by the operator outside of the vibration welding machine are added, a work environment can be improved and thus work efficiency can be maximized.

As another embodiment of the present invention, temperature information in a machine obtained by a temperature-measuring device 55 may also be used to generate a resonance frequency with a reverse phase of a specific frequency of noise so as to reduce, remove, or precisely control the corresponding noise by separately providing at least one or more resonators capable of reducing and effectively cancelling noise on an upper surface of a lower end jig 33 or a work table 31.

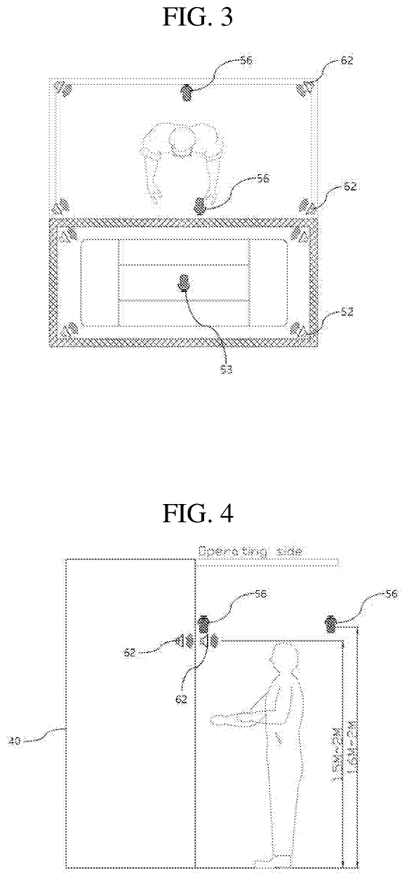

The configuration of the external microphones 56 illustrated in FIG. 3 is for measuring a level of noise actually transmitted to the outside after noise generated in the machine is cancelled, and the noise transmitted to the outside is input through the external microphones 56, transmitted to a noise analyzer 51 and provides feedback information about whether the noise is actually cancelled. Simultaneously, the external microphones 56 may be used to obtain noise from a space, in which the operator is positioned outside of the welding machine, and to transmit the noise to the noise analyzer 51 such that a frequency, an amplitude, and a noise value of the corresponding noise can be analyzed to output a cancellation sound, which is capable of cancelling the noise, through outward speakers 62.

According to the present invention, since a frequency, which has a reverse phase of a specific frequency of vibrations generated during a vibration welding work and changes the vibrations to new vibrations, is generated to output a cancellation sound wave, a cancellation action occurs between the frequency of the noise and the frequency with the reverse phase to reduce or block working noise, and thus a risk of discomfort and hearing loss of the operator can be minimized, and noise pollution can be prevented.

As described above, in a noise reduction vibration welding machine using frequency cancellation according to the present invention, since an analyzer generates and outputs a cancellation sound wave of which a phase is shifted from a phase of a specific frequency of noise generated when vibration welding work is performed, a frequency of the cancellation sound wave with the reverse phase performs a cancellation action, and thus work noise can be reduced or blocked so that discomfort and hearing loss of an operator can be minimized and noise pollution can be prevented.

While the embodiments and applications of the invention have been shown and described, it will be understood by those skilled in the art that various changes and modifications may be made without departing from the spirit and scope of the invention as defined by the appended claims.

What is claimed is:

1. A noise reduction vibration welding machine using frequency cancellation, comprising:
a head frame (10) in which a vibration spring (11) is provided in a central portion and electromagnetic coils (12) are provided at both side end portions of the vibration spring (11) and which includes an upper end jig (13) at an lower end portion and an upper end fixture (14) under the upper end jig (13);
a lower frame (20) which supports both side surfaces of the head frame (10), includes a guide shaft coupling part (21) inside an upper portion thereof, and is coupled to guide shafts (22);
a pressing unit (30) including a work table (31) in which the guide shafts (22) pass through both side end portions of the work table (31), a hydraulic cylinder (32) under the work table (31), a lower end jig (33) on the work table (31), and a lower fixture (34) on the lower end jig (33);
a soundproof case (40) in which the head frame (10), the lower frame (20), and the pressing unit (30) are installed; and
a noise controller (50) including a noise analyzer (51) on one side surface inside the soundproof case (40), at least one or more speakers (52) facing a noise source at each inner corner, an internal microphone (53) in a central portion of the head frame (10), and a machine acceleration sensor (54) on the electromagnetic coil (12),
wherein outward speakers (62) are provided in the soundproof case (40) to face the outside where an operator is positioned.

2. The noise reduction vibration welding machine of claim 1, wherein a temperature-measuring device (55) is provided in a central upper portion in the soundproof case (40).

3. The noise reduction vibration welding machine of claim 1, wherein an external microphone (56) is provided outside the soundproof case (40), and
wherein a frequency of generated noise is transmitted as an input value of the noise analyzer (51).

4. The noise reduction vibration welding machine of claim 1, wherein the noise analyzer (51):
receives values of a frequency, an amplitude, and noise through components of the noise controller (50);
generates a cancellation sound a having a phase signal with the same frequency and amplitude and a phase shifted by 180°; and
outputs the cancellation sound through the speaker (52).

5. The noise reduction vibration welding machine of claim 1, wherein the speakers (52) are provided at corners of upper end portions inside the soundproof case (40),
wherein two speakers (52) are positioned at two lateral end portions of the corners facing the upper and lower end jigs which are noise sources, and
the other speakers (52) are positioned at two end portions of the other corners opposite to the two lateral end portions to face a direction, which is the same as a direction in which the two speakers (52) face, so that the other speakers (52) face the external microphone (56).

6. The noise reduction vibration welding machine of claim 1, wherein:
an acceleration sensor (61) is provided in the head frame (10) in which the vibration spring (11) is positioned; and
acceleration sensors (61) are provided on outer side surfaces of the upper end fixture (14) and the lower fixture (34).

7. The noise reduction vibration welding machine of claim 3, wherein:
the external microphone (56) is positioned on an outer side surface of the soundproof case (40) at a height ranging from 1.6 m to 2 m from a ground surface; and
another external microphone (56) is additionally provided to be spaced 1 to 2 m from the external microphone (56) and is provided at the same height as the external microphone (56).

8. The noise reduction vibration welding machine of claim 1, wherein:
the outward speakers (62) are provided to be positioned at a height ranging from 1.5 m to 2 m from a ground surface; and
other outward speakers (62) are additionally provided on an outer side surface of the soundproof case (40) and are provided at the same height as the outward speaker (62), to face the operator.

9. The noise reduction vibration welding machine of claim 8, wherein:
the outward speakers (62) may be disposed at both end portions of the soundproof case (40); and
the additional outward speakers (62) are provided to be spaced 1 m to 2 m from the outward speakers (62) in a linear direction toward the outside from a vertical surface of the soundproof case (40),
wherein the four outward speakers (62) are provided facing a front surface or the operator.
